(19) United States
(12) Patent Application Publication
(10) Pub. No.: US 2016/0057168 A1
(43) Pub. Date: Feb. 25, 2016

(54) SYSTEM AND METHODS FOR EFFICIENT NETWORK SECURITY ADJUSTMENT

(71) Applicant: TACTEGIC HOLDINGS PTY LIMITED, Kowloon, Hong Kong (CN)

(72) Inventor: Stephen David REDDOCK, Redfern (AU)

(21) Appl. No.: 14/784,577

(22) PCT Filed: Apr. 15, 2014
(86) PCT No.: PCT/IB2014/001678

§ 371 Date: Oct. 14, 2015

Related U.S. Application Data
(60) Provisional application No. 61/812,135, filed on Apr. 15, 2013.

(51) Int. Cl. H04L 29/06

(52) U.S. Cl. CPC H04L 63/20; H04L 63/105; H04L 63/02

(57) ABSTRACT

Various of the disclosed embodiments contemplate systems and methods for implementing network security without extensive remodeling of the network infrastructure. Rather than redesign a network topology to accommodate a plurality of firewall devices at the network periphery, various embodiments introduce localized access proxy systems, e.g., into an existing legacy network. Rule sets operating at the local proxies may ensure compliance with various security standards (e.g., PCI-DSS) without requiring an extensive overhaul of the network's connections.

### CROSS-REFERENCE TO RELATED APPLICATIONS

This application claims priority to PCT Patent Application No. PCT/IB2014/001678, filed Apr. 15, 2014, which claims priority to the U.S. Provisional Application 61/812,135, entitled “SYSTEM WHICH ENABLES PCI-DSS COMPLIANCE FOR ENTERPRISES”, filed on Apr. 15, 2013.

### FIELD OF THE INVENTION

Various of the disclosed embodiments relate to systems and methods for providing network security, e.g., to comply with a security standard, in legacy network systems and/or without requiring substantial modification of a network topology.

### BACKGROUND

Many challenges face businesses maintaining secure networks for their enterprise. For example, businesses dependent upon cloud computing infrastructures or which offer their products via Software-As-A-Service (SAAS) must regularly adapt and upgrade their systems to remain current with ongoing developments. Compliance obligations such as privacy acts, HIPAA (Health Insurance Portability & Accountability Act) and PCI-DSS (Payment Card Industry Data Security Standard) also require businesses to adapt their security practices or face increasing costs, high risk levels, or functional restrictions. Compliance with PCI-DSS is mandatory for merchants and service providers. However, merchants are struggling with the compliance requirements as evidenced by regular reports of breaches, even among merchants considered to be compliant. Issuers and acquirers have also found compliance difficult, as compliance often requires that they segment their large and complex networks using firewall topologies requiring significant network redesign.

While some businesses may seek compliance by overhauling their legacy networks and instituting a modern firewall-based infrastructure, such an approach may be extremely expensive and time consuming. The overhaul may be traumatic for their operations and the consequent redesign of their internal systems may itself present new opportunities for security breaches. Accordingly, these entities would often prefer to retain their legacy network, but to achieve a degree of compartmentalization and additional security necessary to comply with their various obligations. Systems and methods which can provide internal security in a legacy network, without the sweeping redesigns required by firewall implementations, are desired.

### SUMMARY

Certain embodiments contemplate a computer-implemented method comprising the steps receiving a first portion of an application connection destined for a destination device, determining that access rights of a user associated with the application connection permit transmission of the first portion of the application connection to the destination device, determining that at least a subset of a plurality of configuration rules are satisfied in relation to the application connection so as to permit transmission of the first portion of the application connection to the destination device, determining that satisfaction of the subset of the plurality of configuration rules is sufficient to permit transmission of the first portion of the application connection to the destination device; and causing the first portion of the application connection to arrive at the destination device.

Certain embodiments contemplate a non-transitory computer-readable medium comprising instructions configured to cause one or more processors in a computer system to perform a method, comprising receiving a first portion of an application connection destined for a destination device; determining that access rights of a user associated with the application connection permit transmission of the first portion of the application connection to the destination device; determining that at least a subset of a plurality of configuration rules are satisfied in relation to the application connection so as to permit transmission of the first portion of the application connection to the destination device; determining that satisfaction of the subset of the plurality of configuration rules is sufficient to permit transmission of the first portion of the application connection to the destination device; and causing the first portion of the application connection to arrive at the destination device.

Certain embodiments contemplate a computer system comprising: at least one processor; and at least one memory comprising instructions configured to cause the at least one processor to perform a method comprising: receiving a first portion of an application connection destined for a destination device; determining that access rights of a user associated with the application connection permit transmission of the first portion of the application connection to the destination device; determining that at least a subset of a plurality of configuration rules are satisfied in relation to the application connection so as to permit transmission of the first portion of the application connection to the destination device; determining that satisfaction of the subset of the plurality of configuration rules is sufficient to permit transmission of the first portion of the application connection to the destination device; and causing the first portion of the application connection to arrive at the destination device.

In some embodiments, determining that satisfaction of the subset of the plurality of configuration rules is sufficient to permit transmission of the application connection to the destination device comprises satisfying at least a portion of the compliance criteria for PCI-DSS. In some embodiments, causing the first portion of the application connection to arrive at the destination device comprises issuing a signal such that a downstream system grants access in compliance with the PCI-DSS policies of an enterprise. In some embodiments, the application connection is received from one of: an end user computing device; a server; a service bus; networking equipment such as a switch or router; and a firewall or other computational appliance. In some embodiments, the method further comprises creating a record indicating that the first portion of the application connection was caused to arrive at the destination device. In some embodiments, the method further comprises redacting at least a portion of the first application connection based upon the configuration rules. In some embodiments, the method further comprises encrypting at least a portion of the first application connection.

### BRIEF SUMMARY OF THE DRAWINGS

One or more embodiments of the present disclosure are illustrated by way of example and not limitation in the figures of the accompanying drawings, in which like references indicate similar elements.

FIG. 1 is a block diagram depicting an example network topology as may occur in some embodiments.

FIG. 2 is a block diagram depicting an example network topology involving an access proxy server as may occur in some embodiments.

FIG. 3 is a block diagram depicting an example alternative administrator deployment network topology involving an access proxy server as may occur in some embodiments.

FIG. 4 is a block diagram depicting an example multiple access proxy server topology as may occur in some embodiments.

FIG. 5 is a flow diagram depicting an example decision process as may occur at an access proxy in some embodiments.

FIG. 6 is a table depicting scope management features as may apply in some embodiments.

FIG. 7 is a table depicting various example assessment procedures and compliant statements corresponding to PCI-DSS compliance as may apply in some embodiments.

FIG. 8 is a table depicting various example assessment procedures and compliant statements corresponding to PCI-DSS compliance as may apply in some embodiments.

FIG. 9 is a table depicting various example assessment procedures and compliant statements corresponding to PCI-DSS compliance as may apply in some embodiments.

FIG. 10 is a block diagram of a computer system as may be used to implement features of some of the embodiments.

### DETAILED DESCRIPTION

The following description and drawings are illustrative and are not to be construed as limiting. Numerous specific details are described to provide a thorough understanding of the disclosure. However, in certain instances, well-known details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

### System Overview

Various of the disclosed embodiments contemplate systems and methods for implementing network security without extensive remodeling of the network infrastructure. Rather than redesign a network topology to accommodate a plurality of firewall devices at segmented peripheries, various embodiments introduce localized access proxy systems, e.g., into an existing legacy network. Rule sets operating at the local proxies may ensure compliance with various security standards (e.g., PCI-DSS) without requiring an extensive overhaul of the network's connections.

The access proxy may satisfy an enterprise's business, compliance, and risk management objectives, while still allowing flexible integration with service providers, legacy networks and agile business practices. Though for purposes of explanation the discussion herein may regularly refer to the example of PCI-DSS compliance, one will recognize that the same or similar rules, methods, and devices will mutatis mutandis apply to other compliance schemes.

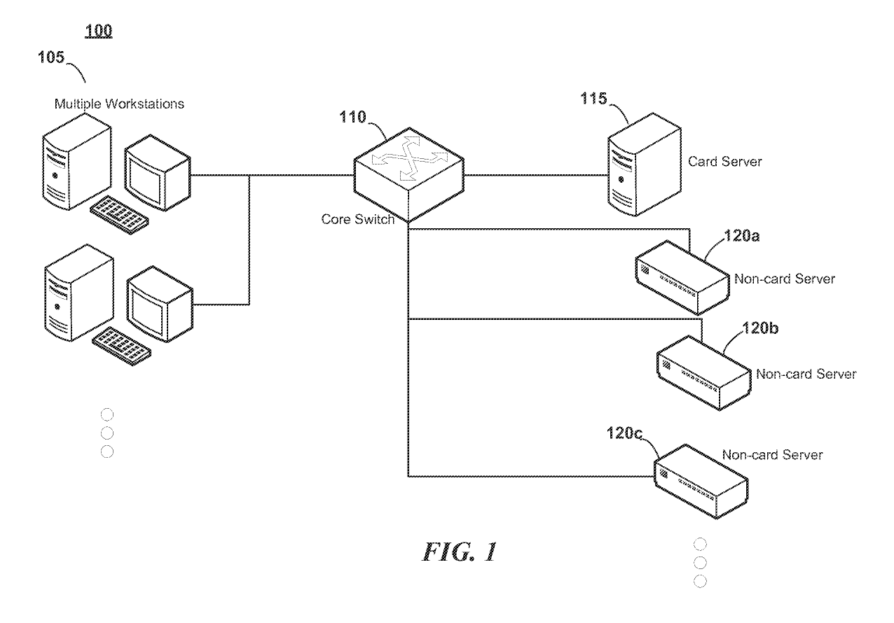

FIG. 1 is a block diagram depicting an example network topology 100 as may occur in some embodiments. Various workstations 105 may seek to communicate with non-card servers 120a-c or with card server 115 across a network via switch 110. Though “card” and “non-card” are here used to reflect “sensitive” and “non-sensitive” data systems, one will recognize that other sensitive systems will apply in other domains (e.g., patient records, banking records, etc.). Furthermore, the simplicity of the depicted topology in FIG. 1 may not reflect the complexity of a real-world legacy system. Even so, the direct methods discussed herein with reference to the simplified form, may be scaled to apply to more complex topologies.

In this simple example card-data network, all servers and workstations will need to be in scope for PCI-DSS compliance, whether they do or do not contain cardholder data. Conventional PCI-DSS remediation would accordingly require that firewalls be added to separate servers 115 containing cardholder data from other servers 120a-c, and also to separate workstations 105 between those requiring cardholder access and those which do not.

As discussed above, it is not always necessary, or even desirable, for firewalls to be used for internal network segregation. Various embodiments contemplate an access proxy server 210 facilitating compliance without the difficulties accompanying firewall implementations.

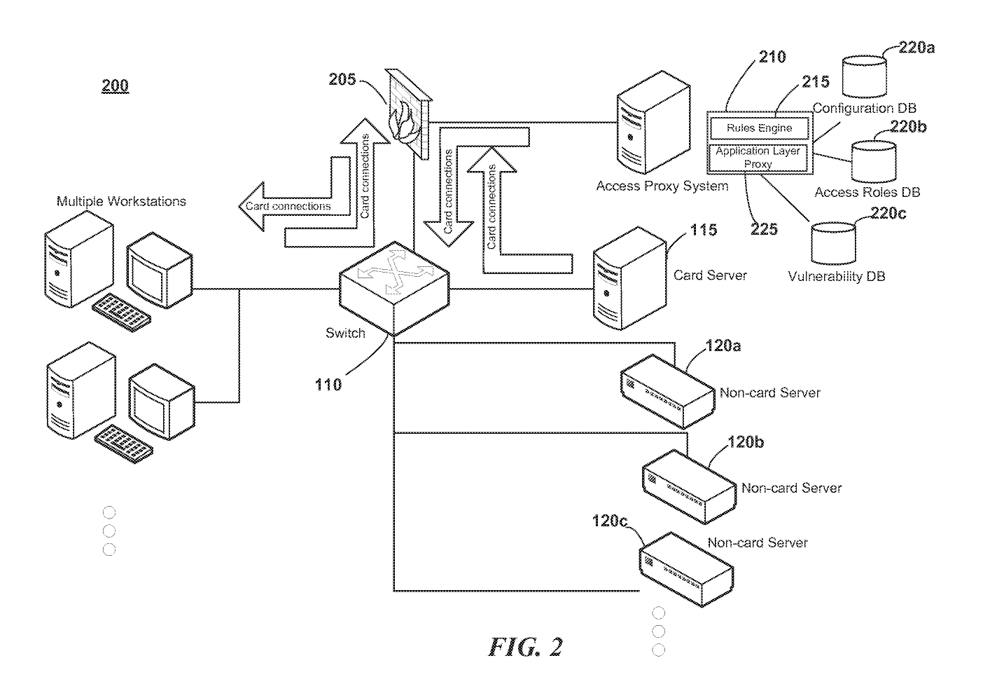

FIG. 2 is a block diagram depicting an example network topology involving an access proxy server 210 as may occur in some embodiments. In this example, a simple modification to the routing procedures at switch 110 requires connection to the card server 115 to pass through the access proxy system 210. The access proxy system 210 may include a rules engine 215 configured to determine whether a packet is suitable for delivery to/from the card server 115. The rules engine may apply user authorization and proxy certificate identification as part of the rule application process. The rules engine may also consult information from various databases which may include a configuration database 220a (which may be a near-real-time configuration database), an access roles database 220b, and a vulnerability database 220c. The firewall 205 may be used to protect the access proxy system 210, but is not required.

Near Real-Time configuration database 220a may be a system of records describing the desired configuration attributes of the various servers, systems and applications running on the card server 115. Database 220a may also receive a feed of the actual server configuration on a near-real time basis to compare with the desired configuration. Any differences between the two may be noted as non-compliances in accordance with business rules. Of all configuration attributes within the system only failure to meet a subset may be considered important enough to constitute “non-compliance”. Other subsets may be accepted. Such behavior may be preexisting in the enterprise or may be part of the access proxy system. For example, the access proxy system may contain expected settings for password complexity, running services, and installed applications.

In some cases all requests will pass through the access proxy system 210, but access to non-card servers 120a-c will be performed in the usual manner. In some embodiments, the card server 115 may be altered to accept connections from the access proxy system 210, while other access accounts may be prohibited. This may be achieved by multiple methods, e.g.: a web service bus could be updated to require that all requests be proxied by the access proxy system; authorization systems could be modified; inline proxies could be deployed; out of band proxies may be used; etc. Enterprise architectures today may be very flexible. Many applications on the card server may be web applications or web services. Accordingly, there are multiple methods of providing access to these services by different types of proxies, service busses, direct server access, federated identity management for authorization, etc.

In some embodiments, there may no longer be direct connections to card server 115. Users requiring access to cardholder data will pass their packets through access proxy system 210. In these embodiments, without such access authorization from access proxy system 210 the user will not be able to connect to the card data and therefore their workstation will be out of scope.

The response of the access proxy system 210 to a packet can vary by role and associated permissions of the requester. For example a fraud investigator may have an explicit business need to access the full PAN (Primary Account Number) and would be appropriately authorized. The investigator's requests would be honored in full. However a business analyst preparing generic reporting may not require the full PAN for their reports. The data desired by the business analyst may be in the same server system as that to which the fraud team connects. In this circumstance, the business analyst may be considered to be connecting to a CDE (Cardholder Data Environment) system and therefore in scope for PCI-DSS. A CDE is a system which stores, processes or transmits cardholder data. A CDE may be required for PCI-DSS compliance. In this instance, the access provisioned through the access proxy system 210 may be a restricted service which would only return the truncated PAN, or perhaps a tokenized PAN. In either instance, the workstations would be considered out of scope for PCI-DSS compliance and the auditing within the access proxy system 210 solution may be able to positively verify this point.

Improved security generally depends upon various factors, including access control, enforcement of “least privilege” access, logging and auditing. These principles generally apply, e.g., to SAAS models, small business, large enterprise, cloud computing and PCI-DSS compliance. “Least privilege” access limits access to systems to only those users and workstations which require access. In PCI-DSS, e.g., this may be used to minimize the scope of the compliance activities for ease of management, risk reduction, business impact and cost reduction. The PCI-DSS standard calls for network segmentation to remove systems from scope so as to implement “least privilege”. While this may be achieved via firewall type segmentation this isn't necessarily required.

Firewall segmentation is intended to achieve the following core goals: Low level network isolation; Act as a Policy Enforcement Point (PEP) for a second layer of defense to prevent connections to erroneously enabled services; Access to intended services is only permitted to authorized computers; Application layer proxies. These goals can be achieved by other methods in some embodiments, whereby evidence of controls and restrictions of access can be provided which meet requirements such as: low-level network isolation; act as a Policy Enforcement Point (PEP) for a second layer of defense to prevent connections to erroneously enabled services; and access to intended services is only permitted to authorized computers.

Accordingly, various embodiments of the access proxy system 210 discussed herein manage access to sensitive data in a broad range of environments so as to meet the business risk requirements. Additionally, the access proxy system 210 may manage external standards such as privacy acts, HIPAA and PCI-DSS. Non-firewall-based segmentation may be used to reduce the scope of a PCI-DSS compliance program. Segmentation may separate sensitive systems from networked systems to manage the security.

The access proxy system 210 may route user access decisions through an application layer proxy 225, which may be mounted behind a firewall 205, as part of or separate from access proxy system 210. The application layer proxy may receive the data request from the upstream system (workstation or server) and evaluate the request. The request may be treated in accordance with the business rules and the data from additional attributes such as the databases 220a, 220b, 220c. In some embodiments, both access decisions and traffic may also be routed through the access proxy system 210. Generally, creating this secured zone should be less difficult than the large scale migration of the conventional firewall approach. This access proxy system 210 may also provide tokenization to further reduce the workstations from scope. Tokenization may include when a user without access permissions for the full PAN requests the PAN. The returned data could be replaced with a reference token instead. This reference token would not be considered sensitive and could be re-associated with the PAN at a later stage in the process if required. The format of the reference token may vary depending on requirements, but may be, e.g., a 16 digit numerical field.

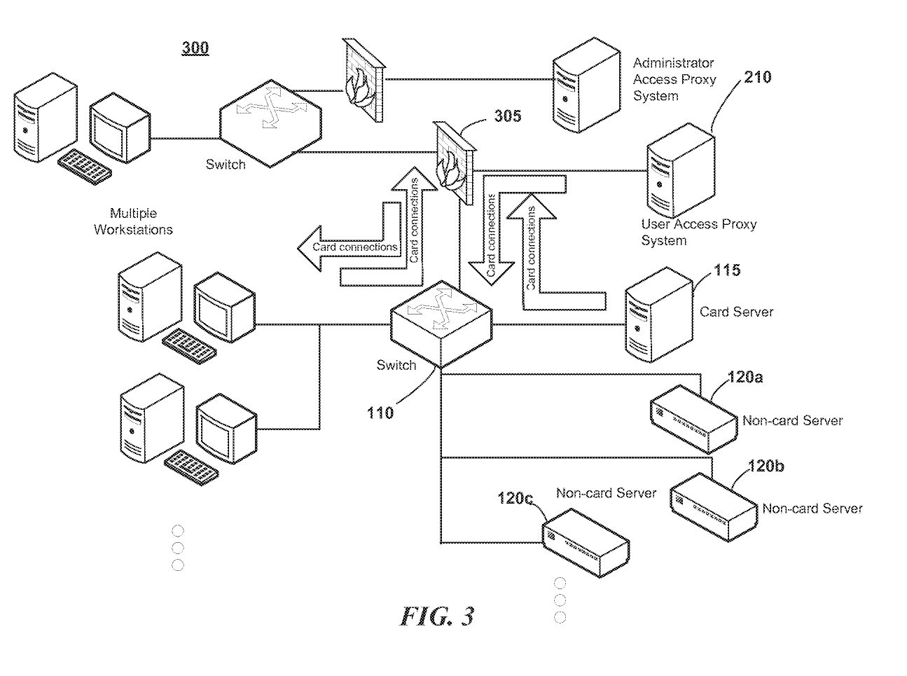

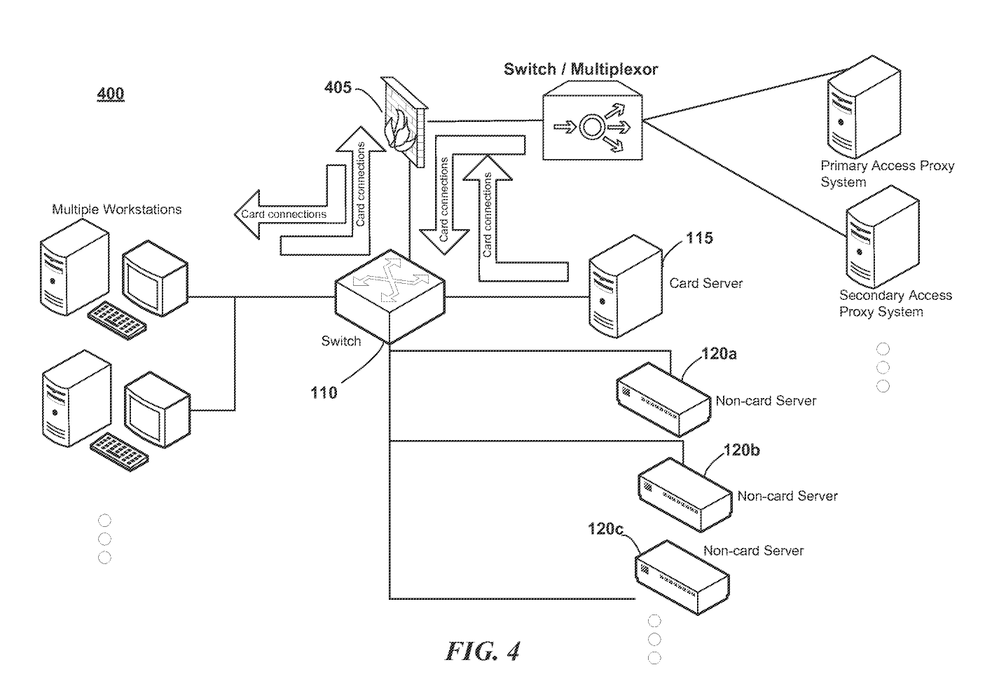

One will readily recognize variations of the above topology. For example, FIG. 3 is a block diagram depicting an example alternative administrator deployment network topology involving an access proxy server as may occur in some embodiments. FIG. 4 is a block diagram depicting an example multiple access proxy server topology as may occur in some embodiments.

### Rules Engine Operation

In some embodiments, rules engine 215 may be configured to consider numerous factors, including: various business requirements, risk conditions, compliance regimes, other deployed technologies, etc. Generally, rules engine 215 considers more variables and conditions than typically occur in network firewalls. For example, the following five rules address disparate factors and domains:
1. If (user is authenticated AND user role allows access to data or resource requested AND server configuration matches baseline policy AND server vulnerabilities are all low severity) THEN (grant access AND audit) ELSE (deny access AND audit)
2. If (resource requested is defined as out of scope) THEN (grant access AND audit)
3. If (user is authenticated AND user role allows access to non-sensitive resources AND resource requested is non-sensitive) THEN (grant access AND audit) ELSE (deny access AND audit)
4. If (user is authenticated AND user role allows access to data or resource requested AND server configuration matches baseline policy AND server vulnerabilities are all low severity) THEN (grant access AND audit) ELSE (grant access AND audit AND create real-time incident ticket)
5. If (user is authenticated AND user role allows access to data or resource requested AND server configuration matches baseline policy AND server vulnerabilities are all low severity) THEN (grant access AND audit AND replace sensitive data with a reference token) ELSE (deny access AND audit)

Rule behavior can be defined such that certain rules take precedence over others (e.g., in a partial or total ordering). Evaluation of the rules may then be performed in this order. In some embodiments, the rules are defined affirmatively such that when a rule is satisfied the system does not consider the remaining rules. In some embodiments, satisfaction of a rule may result in additional actions being performed (e.g., rearranging the ordering of subsequent rules, identifying new rules to consider, performing operations relevant to the satisfied rule's context, etc.).

Generally, access will only be granted when the user rights are appropriate and the additional authorization attributes are also correct. However, unless indicated otherwise herein, in some embodiments and situations access may still be granted despite certain violations of some authorization attributes rules, if the rules that are satisfied, or the circumstances of the request, are in accordance with business requirements (e.g., rule compliance may be unnecessary during certain times of the year for a business). That is, in some situations the business requirements may take precedence to the authorization attributes rule. A priority audit event may still be logged such that records are kept or an exceptions processing workflow is triggered.

The exceptions workflow may be a process triggered when the system doesn't quite meet the business rules (e.g., only a handful of rules are not met), but the business has chosen, e.g., to accept the violation, complete the transaction and then deal with the consequences after the fact. An example exceptions workflow could be to investigate the rule exception, determine the root cause, instigate emergency remediation, trigger a review of transactions performed in the last 24 hours, etc.

PCI may require the system to detect changes in configurations on a daily basis. In view of this, short lived configuration errors may be acceptable to the business and accordingly allowed, despite not necessarily meeting all the business rules.

Implementing the rules engine 215, the access proxy system 210 will be configured to monitor for connection requests to systems containing sensitive information, in accordance with policy. The definition of “sensitive” may vary depending upon the use case. For example, sensitive information may be credit card information such as the PAN, social security numbers, health information, etc. In some embodiments, when a network device (e.g., the switch 110) receives a packet concerning sensitive information, it may contact the access proxy system 210 or some other form of Authentication, Authorization and Auditing (AAA) system for an authorization policy decision. Unlike other AAA's, the access proxy system may correlate the configuration DB, vulnerability DB, business rules and the access roles DB. This system is known as a Policy Decision Point (PDP). The PDP may verify that the access rights correlate with various additional external attributes in relation to the access request.

### Process Flow

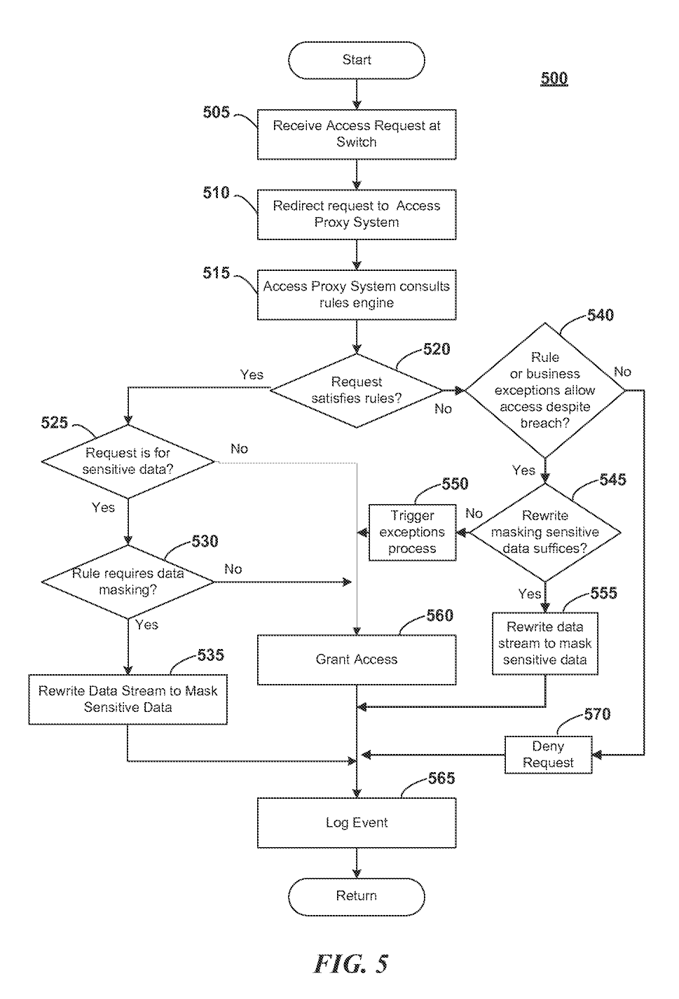

FIG. 5 is a flow diagram depicting an example decision process 500 as may occur in some embodiments.

At block 505, the switch 110 may receive an access request, e.g., an access request to the card server 115, from a workstation 105.

At block 510, the switch 110 may redirect the access request to the access proxy system 210.

At block 515, the access proxy system 210 may consult a rules engine as regards the request.

If it is determined that the request satisfies the rules at block 520, the system may determine if the request is for sensitive data at block 525. “Sensitive” may be defined in the business rules stored in the rules engine component of the access proxy system or in an external database. If the request is for sensitive data, the system may determine if the rule requires masking at block 530. If so, at block 535 the system may rewrite the data stream to mask the sensitive data. For example, a credit card PAN could be re-written to be an reference token. Certain digits may be replaced with X's such that no more than the first six digits and last four digits remain. For example, 4940 5849 4568 4561 1234 could be changed to 4940 58XX XXXX XXXX 1234. If the request is not sensitive, then the access proxy system 210 may grant access at block 560.

Where the request does not satisfy the rules (and/or the corresponding business context) at block 520, the system may consider at block 540 whether the rule or business exceptions allow access despite the breach. If not, the request may be denied at block 570. If an exception is allowed, the system may determine at block 545 if rewriting the sensitive data with a mask suffices. If rewriting does not suffice, the exception process may be triggered at block 550. If rewriting suffices, at block 555 the system may rewrite the data stream to mask the sensitive data.

In each outcome, the results of the rules determination may be logged at block 565, to retain a record of the transaction. In this manner, the system may provide audit functionality in accordance with business requirements and provide evidence and assurance that only appropriate access is granted.

### PCI-DSS Compliance

Some embodiments seek to achieve PCI-DSS compliance using the access proxy system 210. The PCI-DSS standard seeks to separate the Cardholder Data Environment (CDE) from the remainder of the network by “segmentation”. The segmentation for the PCI-DSS standard (page 11) is explained as: “Network segmentation can be achieved through a number of physical or logical means, such as properly configured internal network firewalls, routers with strong access control lists, or other technologies that restrict access to a particular segment of a network. To be considered out of scope for PCI DSS, a system component must be properly isolated (segmented) from the CDE, such that even if the out-of-scope system component was compromised it could not impact the security of the CDE.”

The first sentence provides examples of segmentation technology. While many prior art systems have sought to satisfy the standard with firewall systems and topological reorganizations, various of disclosed embodiments still satisfy the standard without these more arduous implementation techniques. For a component to be considered “out of scope” the standard requires that the “system component must be properly isolated (segmented) from the CDE, such that even if the out-of-scope system component was compromised it could not impact the security of the CDE.”

Embodiments of access proxy system 210 may meet this standard by providing protection such that even when an out of scope system component is compromised, it cannot impact the security of the CDE. This achieves the control objective of the standard, but also the control objectives of security best practice. The access proxy system may provide evidence that all access to cardholder data, and access to the associated systems, were made to systems configured securely and in accordance with policy. Evidence may be provided that the users requesting this access had appropriate permissions. Should a request be from a system and/or user which does not have appropriate permissions to access the cardholder data it will be denied either by the access proxy system or the server or system containing the cardholder data. Either result shall be appropriately audited in some embodiments.

### Scenarios and Calling Methods

In some embodiments, various assumptions may be made regarding the context in which the access proxy system 210 operates. A directory, or some method of tracking user permissions, rights and or group management may be used, either externally or within the access proxy server 210. This user database may be contacted to determine if the user has the permissions to access the requested data.

Additional authorization attributes may be acquired by the access proxy server 210 from a near real-time configuration, patch management databases, workstation identity, geo-location, etc. These features may be specified as flexible business rules. If remote access is permitted, but there is no reason for work to be performed from certain countries then access can be blocked as a form of risk-based authorization. A second factor such as a number from a key-fob token may be required when access is not from within the home country. Additional authentication controls (such as two-factor tokens) may be called for correlation with the user access request. The nature of the additional authorization attributes may be customizable and may vary according to the specific use case.

In some embodiments, the data flow may be proxied through access proxy server 210. In some embodiments, the authorization decision may be passed to the target system to facilitate serving the data directly. The access proxy system may act as a Federated Identity Manager (FIM) in some situations. Once the access request was granted the communication may be directly from client to server in some embodiments.

In some embodiments, the nature of the access granted can be determined by policy. The nature of the access can include, e.g.: full access; access only to redacted data; replacement of certain sensitive fields with reference tokens; and encryption of the data (either during upload or download). Varying access levels may apply in a pass-through proxy model and also when an authorization decision is sent to a system for direct fulfillment. In the latter instance, the authorization message may be enriched with the type of access to grant.

In some embodiments, all access attempts and the resulting outcomes will be audited in accordance with a rules policy. Auditing may be incorporated into the access proxy system, though the enterprise may already have a robust auditing system. The existing auditing system may be utilized as a remote audit log collection system.

### Scenarios and Calling Methods—Stand-Alone Access Proxy System

In some embodiments the server hosting an application, or the user initiating the request, may direct the access request to the access proxy 210. The access proxy 210 may perform a lookup of a user authorization record, e.g., internally or with reference to an external directory service, and determine if access should be granted based upon user rights. In some embodiments, the user information may be correlated with various other attributes such a near-real-time configuration verification, workstation verification, etc. to determine if access should be granted.

Granted data access requests may be served directly from the called application, or further redirected through an access proxy 210. The access proxy 210 may be instructed by comparing the user request, attribute validation and business rules as a complete set of sensitive data. The system may selectively redact data according to policy by editing the data flow to remove certain data in accordance with business rules defined in the access proxy system, or replace certain data with a reference token in accordance with business rules defined in the access proxy system. All access attempts (successful or denied) may be logged in accordance with required policies.

### Scenarios and Calling Methods—Networking Equipment Integration

In some embodiments, networking equipment may be configured to monitor for connection requests to systems containing sensitive information, e.g., in accordance with a security policy. When a sensitive connection is detected the networking equipment may contact the access proxy 210 to serve as an Authentication, Authorization and Auditing (AAA) system for an authorization policy decision. The access proxy 210 may operate as, or operate in conjunction with, a Policy Decision Point (PDP). The PDP may verify the access rights and may correlate various additional external attributes in relation to the access request. For example, user access roles, the near real-time configuration DB and the vulnerability database can be correlated to the business rules. Access may only be granted when all the attributes are correct. Data access requests granted may be served directly from the called application, or further redirected through an access proxy 210. The stand-alone access proxy method may rely on the server requesting validation from the access proxy prior to performing access.

In the integration with the networking equipment scenario the networking equipment may detect that the request is for or includes the sensitive data. The device may make the decision to request validation from the access proxy prior to passing the data request.

### Federated Single Sign-on Solution Integration

In some embodiments, the called application (running on the card server) redirects the user request to a federated Single Sign-On (SSO) solution which calls additional external attributes in relation to the access request. The access proxy system may be integrated with the FIM systems such that the access request may be correlated with various other attributes such as a near-real-time configuration verification, workstation verification, etc. to determine if access should be granted in accordance with defined business rules.

### Access Proxy System as a Service

Many security solutions today are offered as a service. The access proxy 210 may also be provided in this manner. For example, the as a service deployment may be based around the Federated SSO scenario. In these embodiments, the desired components may be hosted by a service provider and draw inputs from various attribute services either incorporated into their service model, or accessed from their customers' systems. For example, the access proxy system, the access roles DB and the near real-time configuration DB could be hosted by a service provider. The vulnerability DB may be an existing system in use on the customer's network and may be remotely accessed by the service provider to gather the necessary data to make an authorization decision.

Integration within a Shared Service Environment

Pursuant to the security guidelines discussed herein, access to information needs to be clearly segmented such that each customer is only served with their data and not with the data of another customer. Depending upon the information and system architectures of the service provider, additional external attributes for verification prior to access grant could be considered by the access proxy 210, such as: verification that the data ownership maps the same company as the access request. The deployment scenario may vary depending upon the shared service provider, but is likely to include components of already mentioned scenarios based upon their business model and customer capabilities.

While conventional security governance practices struggle with shared service environments, the access proxy's 210 additional authorization attributes and flexible rules engine support the monitoring of configurations and changes made by the service provider outside of the oversight of the corporate IT environment. The access proxy model can provide audit evidence that the access was granted because the system adhered to the expected configuration and security levels for each request. Changes made to the service provider's environment may cause the business rule to fail as the near real-time configuration DB would indicate that the configuration is not as desired. This may ensure that the system is configured as specified and is operating within the defined parameters.

Integration within Data or Network Monitoring Systems

The access proxy 210 may monitor network traffic or data flows and be configured to detect sensitive data by examining the data flow to match against defined business rules which identify sensitive data. Once sensitive data is detected the access can be validated independently of the source of the data.

For example, consider the flow of credit card data within a PCI-DSS compliant organization. A user at a workstation may copy card holder data to a portable storage device, or another workstation would not necessarily pass through a system configured to use access proxy 210. In these cases the monitoring solution may perform a real-time access validation request in a manner similar to the “Integration with networking equipment” scenario. In this embodiment the source server of the data may not be known. A different set of rules may be applied within the access proxy based on the relevant information. This may include the configuration of the workstation in use, user access rights to process sensitive data in this manner, attributes of the storage device such as brand or security features, etc. If the operation is within policy it may be allowed to complete. Depending on the business rules, on-the-fly redaction or replacement of the sensitive data with a reference token may be performed, or the data may be encrypted. If required the event may be audited in accordance with business rules.

### Enterprise Service Bus Integration

Many enterprises provide access to systems through a service bus. The methods, systems and techniques described herein map well to a service bus methodology. In this case the authentication decision can be integrated into the service bus, using techniques already described where by the access rights of the user are mapped to the additional authentication parameters.

Alternatively, the access request can be passed through to the server and the determination made at its arrival by integrating the access proxy system with the server containing the sensitive data, much like in the standalone access proxy system integration described above. This may be correlated with various other attributes such a near-real-time configuration verification, workstation verification, etc. to determine if access should be granted in accordance with defined business rules.

### Mapping of Firewall Features to Solution

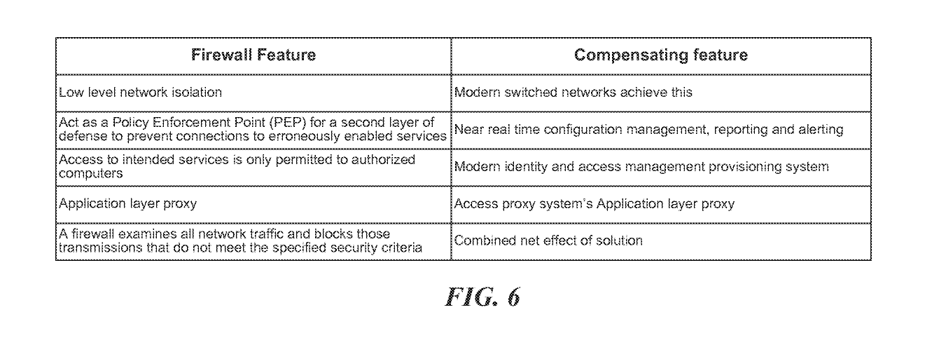

FIG. 6 is a table 600 depicting scope management features as may apply in some embodiments. In this example, firewall features are mapped to analogous compensating features in the access proxy 210 for various PCI-DSS requirements. These features ensure that the segregation requirement is met by isolating the cardholder data systems without the need for expensive server migration projects. Depending upon the enterprise, configuration management, access management provisioning, etc. may already be in place and can be re-purposed for this activity.

Note that the use of the disclosed techniques is not limited to compliance obligations. These approaches may also be used as a generic security or risk management technique across a broad range of enterprises. As an example, the sensitive data to protect might be personal information. Many countries now have privacy acts which define an enterprise's obligations to protect various personal information. The access proxy solution can be utilized to provide secured access to the sensitive data and to prevent non-authorized systems and users from gaining access.

### Example PCI-DSS Requirement Features

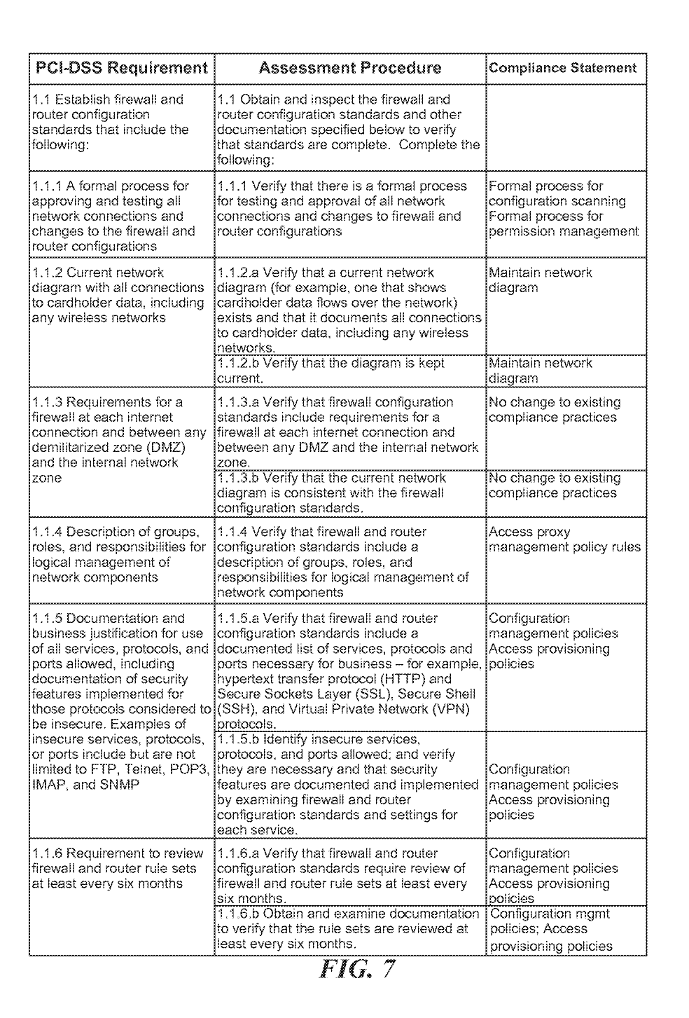

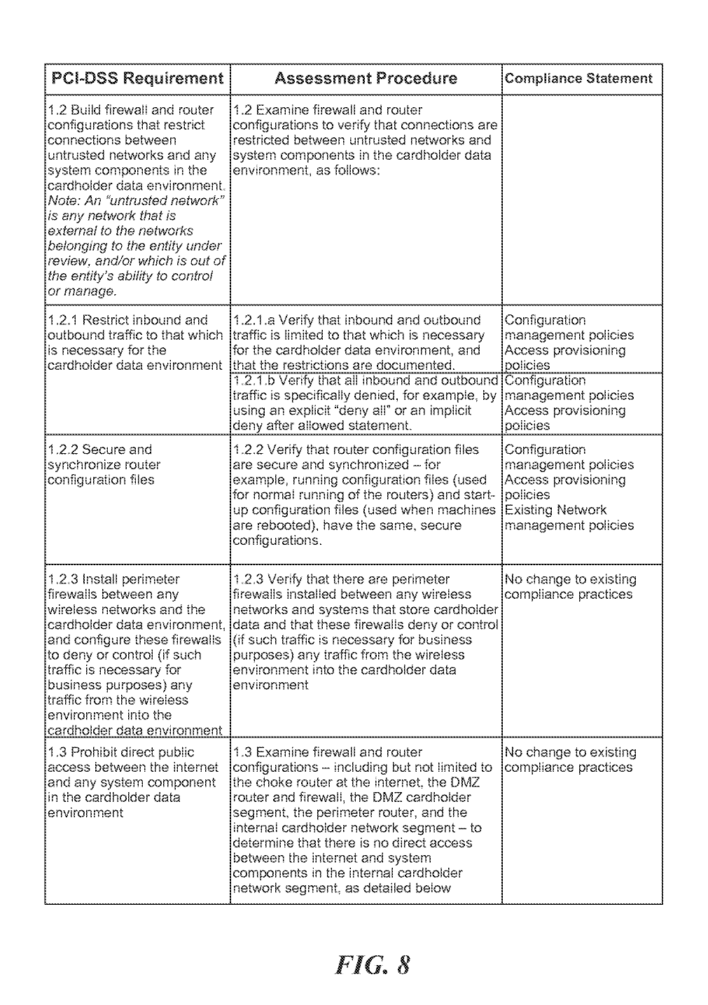

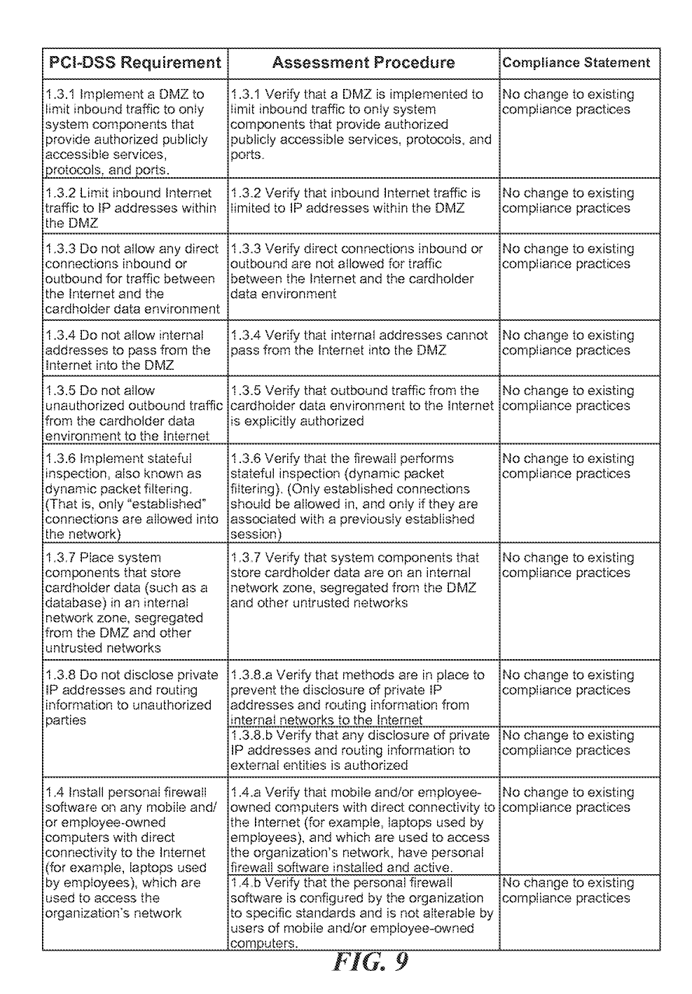

FIGS. 7-9 depict various example assessment procedures and compliant statements corresponding to PCI-DSS compliance as may apply in some embodiments. The assessment column reflects requirements from the standard. The compliance statement indicates how the requirement can be met using various of the disclosed embodiments.

### Various Features

Some embodiments contemplate providing access control to an asset from an un-segmented area of the network. The benefits of segmentation may thereby be provided to that asset, without the requirement to segment. This functionality might be abstracted through a service bus in some embodiments. Generally, the asset to be protected is as much the data as the network server or database it resides on or is transmitted through.

As discussed, some embodiments achieve a PCI-DSS (or other compliance standard) compliant configuration without the expense and complexity of firewalls. This may be achieved by implementing some, or all, of the controls depicted in FIG. 6 and/or: near-real-time configuration management, reporting and alerting; access to cardholder data systems based on roles, groups, permissions or some other logical or physical attribute to identify user/workstation and determine if access is appropriate for the requested resource; preventing access from most workstations demonstrated to be out of scope; and use of content scanning technologies to ensure that sensitive data does not exist on systems considered out of scope. Dependent on the local policies, a risk profile and network configuration may be required to use two-factor authentication for some or all users, devices or connection method, above and beyond the two-factor requirements of PCI-DSS. Depending upon deployment scenarios a risk based authentication system may be employed to: provide input into the decision or to grant access to cardholder data; reject the access request; or substitute truncated cardholder data in the response.

In some embodiments, the access proxy 210 may be built from multiple component systems and may include virtual desktop type solutions to provide further logical separation. The features offered by the access proxy 210 may vary between instances depending on risk factors, technology already deployed in the enterprise, etc.

In some embodiments, the access proxy 210 will not pass the traffic between a client & server, but will only function as an authentication and/or authorization service passing a token or signal to the server specifying the level of access required. In these embodiments, the server configuration may be responsible for ensuring there is no access which is not specifically authorized by the access proxy 210.

In some embodiments, the access grant can be tuned based upon compliance requirements, risk tolerance, and other local factors by creating appropriate business rules within the access proxy system and by integrating with appropriate data sources to support the rule decision. This could be implemented on a sliding scale, e.g., from access being granted for a session for a finite duration to ensuring that each and every request is specifically authenticated and authorized, though this may improve system performance at the trade-off of higher risk.

In some embodiments, there may be multiple instances of the access proxy 210 to facilitate different purposes. For example, these purposes may include: Redundancy & high availability; Load balancing; Different access paths for different purposes (users, system administration, partner access, remote access, etc.).

In some embodiments, the access proxy 210 can have an optional mode whereby the data returned will vary by user role. For example, a fraud administrator could have a requirement and appropriate approval for accessing the full PAN. In contrast, a management level reporting service would not have the required credentials or the authorization for the full PAN. The access proxy 210 may modify the data flow in real time to supply a token or truncated PAN to the management level reporting service, thus rendering it out of scope for PCI-DSS compliance. The access proxy 210 may also do this just to lower the risk profile.

As discussed above, the access proxy 210 may be used to emulate the functionality of a firewall. For example, PCI-DSS specifies a firewall as “examines all network traffic and blocks those transmissions that do not meet the specified security criteria”.

This access proxy 210 may achieve these operations by one or more of the following methods: Network isolation can be achieved by the modern switched network; prevention of connection to erroneously enabled services; modern operating systems which are thoroughly maintained; Near-real-time configuration management to ensure that the operating systems are configured as expected; and thorough access identity and authorization by the access proxy 210.

As discussed, auditing and logging of all allowed connections through the access proxy 210 may be performed in some embodiments. This may be in addition to denied connections and may provide positive validation of systems in scope. Such logging can greatly assist with meeting the PCI-DSS 10.x requirements for log management. The logging may also permit positive determination of systems which are out of scope for compliance—a common PCI-DSS compliance difficulty. Logging may also assist organizations to meet their internal and external log and audit requirements.

Deployment options for the access proxy 210 in some embodiments may include: integrating a range of discrete tools, or decision logic sources and using these to drive a decision engine or integrating the method into existing technology deployed such as in firewalls, networking gear or Authentication, Authorization and Auditing (AAA) equipment or systems; developing an appliance or other deployed/licensed technology or service such that the decision is made within that technology product using information processed internally or by drawing on risk scoring values from external sources; deployment as a service from a remote network location or as Customer Premise Equipment (CPE); deployment within a service provider network such that data flows for one customer can be comprehensively demonstrated as being secure and separate from others; and an extension, customization or configuration of an authentication and authorization service or systems.

### Computer System

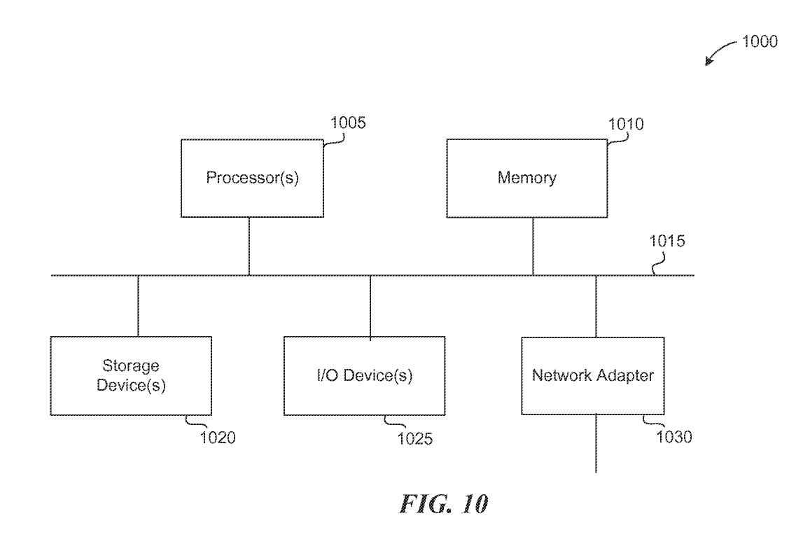

FIG. 10 is a block diagram of a computer system as may be used to implement features of some of the embodiments. The computing system 1000 may include one or more central processing units (“processors”) 1005, memory 1010, input/output devices 1025 (e.g., keyboard and pointing devices, display devices), storage devices 1020 (e.g., disk drives), and network adapters 1030 (e.g., network interfaces) that are connected to an interconnect 1015. The interconnect 1015 is illustrated as an abstraction that represents any one or more separate physical buses, point to point connections, or both connected by appropriate bridges, adapters, or controllers. The interconnect 1015, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 1010 and storage devices 1020 are computer-readable storage media that may store instructions that implement at least portions of the various embodiments. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non-transitory” media) and computer-readable transmission media.

The instructions stored in memory 1010 can be implemented as software and/or firmware to program the processor(s) 1005 to carry out actions described above. In some embodiments, such software or firmware may be initially provided to the processing system 1000 by downloading it from a remote system through the computing system 1000 (e.g., via network adapter 1030).

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

While the computer-readable medium is shown in an embodiment to be a single medium, the term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing, encoding or carrying a set of instructions for execution by the computer and that cause the computer to perform any one or more of the methodologies of the presently disclosed technique and innovation.

The computer may be, but is not limited to, a server computer, a client computer, a personal computer (PC), a tablet PC, a laptop computer, a set-top box (STB), a personal digital assistant (PDA), a cellular telephone, an iPhone®, an iPad®, a processor, a telephone, a web appliance, a network router, switch or bridge, or any machine capable of executing a set of instructions (sequential or otherwise) that specify actions to be taken by that machine.

In general, the routines executed to implement the embodiments of the disclosure, may be implemented as part of an operating system or a specific application, component, program, object, module or sequence of instructions referred to as “programs,” The programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, various embodiments are capable of being distributed as a program product in a variety of forms, and that the disclosure applies equally regardless of the particular type of computer-readable medium used to actually effect the distribution.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for the disclosure, are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teaching of the disclosure provided herein can be applied to other systems, not necessarily the system described above. The elements and acts of the various embodiments described above can be combined to provide further embodiments.

Any patents and applications and other references noted above are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to be limited to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A computer-implemented method comprising:
receiving a first portion of an application connection destined for a destination device;
determining that access rights of a user associated with the application connection permit transmission of the first portion of the application connection to the destination device;
determining that at least a subset of a plurality of configuration rules are satisfied in relation to the application connection so as to permit transmission of the first portion of the application connection to the destination device;
determining that satisfaction of the subset of the plurality of configuration rules is sufficient to permit transmission of the first portion of the application connection to the destination device; and
causing the first portion of the application connection to arrive at the destination device.

2. The computer-implemented method of claim 1, wherein determining that satisfaction of the subset of the plurality of configuration rules is sufficient to permit transmission of the application connection to the destination device comprises satisfying at least a portion of the compliance criteria for PCI-DSS.

3. The computer-implemented method of claim 1, wherein causing the first portion of the application connection to arrive at the destination device comprises issuing a signal such that a downstream system grants access in compliance with the PCI-DSS policies of an enterprise.

4. The computer-implemented method of claim 1, wherein the application connection is received from one of: an end user computing device; a server; a service bus; networking equipment such as a switch or router; and a firewall or other computational appliance.

5. The computer-implemented method of claim 1, further comprising creating a record indicating that the first portion of the application connection was caused to arrive at the destination device.

6. The computer-implemented method of claim 1, further comprising redacting at least a portion of the first application connection based upon the configuration rules.

7. The computer-implemented method of claim 1, further comprising encrypting at least a portion of the first application connection.

8. A non-transitory computer-readable medium comprising instructions configured to cause one or more processors in a computer system to perform a method, comprising:
receiving a first portion of an application connection destined for a destination device;
determining that access rights of a user associated with the application connection permit transmission of the first portion of the application connection to the destination device;
determining that at least a subset of a plurality of configuration rules are satisfied in relation to the application connection so as to permit transmission of the first portion of the application connection to the destination device;
determining that satisfaction of the subset of the plurality of configuration rules is sufficient to permit transmission of the first portion of the application connection to the destination device; and
causing the first portion of the application connection to arrive at the destination device.

9. The non-transitory computer-readable medium of claim 8, wherein determining that satisfaction of the subset of the plurality of configuration rules is sufficient to permit transmission of the application connection to the destination device comprises satisfying at least a portion of the compliance criteria for PCI-DSS.

10. The non-transitory computer-readable medium of claim 8, wherein causing the first portion of the application connection to arrive at the destination device comprises issuing a signal such that a downstream system grants access in compliance with the PCI-DSS policies of an enterprise.

11. The non-transitory computer-readable medium of claim 8, wherein the application connection is received from one of: an end user computing device; a server; a service bus; networking equipment such as a switch or router; and a firewall or other computational appliance.

12. The non-transitory computer-readable medium of claim 8, the method further comprising creating a record indicating that the first portion of the application connection was caused to arrive at the destination device.

13. The non-transitory computer-readable medium of claim 8, the method further comprising redacting at least a portion of the first application connection based upon the configuration rules.

14. The non-transitory computer-readable medium of claim 8, the method further comprising encrypting at least a portion of the first application connection.

15. A computer system comprising:
at least one processor; and
at least one memory comprising instructions configured to cause the at least one processor to perform a method comprising:
receiving a first portion of an application connection destined for a destination device;
determining that access rights of a user associated with the application connection permit transmission of the first portion of the application connection to the destination device;
determining that at least a subset of a plurality of configuration rules are satisfied in relation to the application connection so as to permit transmission of the first portion of the application connection to the destination device;
determining that satisfaction of the subset of the plurality of configuration rules is sufficient to permit transmission of the first portion of the application connection to the destination device; and
causing the first portion of the application connection to arrive at the destination device.

16. The computer system of claim 15, wherein determining that satisfaction of the subset of the plurality of configuration rules is sufficient to permit transmission of the application connection to the destination device comprises satisfying at least a portion of the compliance criteria for PCI-DSS.

17. The computer system of claim 15, wherein causing the first portion of the application connection to arrive at the destination device comprises issuing a signal such that a downstream system grants access in compliance with the PCI-DSS policies of an enterprise.

18. The computer system of claim 15, wherein the application connection is received from one of: an end user computing device; a server; a service bus; networking equipment such as a switch or router; and a firewall or other computational appliance.

19. The computer system of claim 15, the method further comprising creating a record indicating that the first portion of the application connection was caused to arrive at the destination device.

20. The computer system of claim 15, the method further comprising redacting at least a portion of the first application connection based upon the configuration rules.

21. The computer system of claim 15, the method further comprising encrypting at least a portion of the first application connection.
